(19) United States
(12) Patent Application Publication
(10) Pub. No.: US 2019/0145066 A1
(43) Pub. Date: May 16, 2019

(54) SEISMIC ISOLATION BEARING FOR BRIDGE AND BRIDGE USING THE SAME

(71) Applicant: OILES CORPORATION, Tokyo (JP)

(72) Inventors: Osamu KOCHIYAMA, Ashikaga-shi, Tochigi (JP); Kenta NAGAHIRO, Ashikaga-shi, Tochigi (JP)

(21) Appl. No.: 16/092,293

(22) PCT Filed: Apr. 10, 2017
(86) PCT No.: PCT/JP2017/014639

§ 371 Date: Oct. 9, 2018

(30) Foreign Application Priority Data
Apr. 15, 2016 (JP) 2016-082263

(51) Int. Cl. E01D 19/04; F16F 1/40; F16F 15/04

(52) U.S. Cl. CPC E01D 19/041; F16F 15/04; F16F 1/40

(57) ABSTRACT

A seismic isolation bearing for a bridge includes rubber plates, steel plates and a laminated body; a hollow portion provided inside the laminated body in a hermetically closed manner; and a lead plug filled densely in the hollow portion. The lead plug has a pair of rectangular faces extending in a bridge axis orthogonal direction and opposed to each other in a bridge axis direction and a pair of rectangular faces extending in the bridge axis direction and opposed to each other in the bridge axis orthogonal direction.

### TECHNICAL FIELD

The present invention relates to a seismic isolation bearing suitable for use in a bridge (including a highway bridge) having bridge piers (abutments) and bridge girders and bridge using the same.

### BACKGROUND ART

A seismic isolation bearing for a bridge is known which is comprised of a laminated body having alternately laminated elastic layers and rigid layers and a hollow portion defined by inner peripheral surfaces of these elastic layers and rigid layers, as well as a lead plug disposed in the hollow portion of this laminated body and formed of lead as a damping material for damping the shear deformation in a bridge axis direction of the laminated body by absorbing shear energy in the bridge axis direction of the laminated body through plastic deformation.

A seismic isolation bearing interposed between a bridge pier and a bridge girder in a bridge is adapted to support the bridge girder with respect to the bridge pier, and is adapted to attenuate through the plastic deformation of the lead plug the shear deformation in the bridge axis direction of the other end in a laminated direction of the laminated body with respect to one end in the laminated direction of the laminated body owing to the vibration mainly in the bridge axis direction of the bridge girder with respect to the bridge pier on the basis of an earthquake, vehicular passage, the wind, or the like, and also to suppress through the elastic deformation (shear deformation) of the laminated body the transmission, to the bridge girder, of the vibration in the bridge axis direction of the one end in the laminated direction of the laminated body ascribable to the vibration mainly in the bridge axis direction of the bridge girder with respect to the bridge pier.

### PRIOR ART DOCUMENT

### Patent Document

[Patent Document 1] JP-A-2008-232190

### SUMMARY OF THE INVENTION

### Problems that the Invention is to Solve

Incidentally, in the seismic isolation bearing of this type, a circularly columnar body is used as the lead plug, with the result that the shear deformation of the laminated body with respect to all directions within a horizontal plane can be attenuated by that lead plug irrespectively of the bridge axis direction and a bridge axis orthogonal direction. In other words, the shear deformation of the laminated body can be attenuated by the lead plug with non-directionality within the horizontal plane. With the lead plug constituted by such a circularly columnar body, however, in order to largely attenuate shear deformation in a particular direction, e.g., shear deformation in the bridge axis direction, with that lead plug, it is inevitable to use a lead plug of a large diameter, so that the use efficiency of lead is poor, and the seismic isolation bearing is bound to be large in size.

Such plastic flow is not limited to the lead of the lead plug and can also occur in a vibration damping body constituted of other damping material which attenuates the shear deformation in the bridge axis direction of the laminated body by absorbing the shear deformation energy in the bridge axis direction of the laminated body through plastic deformation.

The present invention has been devised in view of the above-described aspects, and its object is to provide a seismic isolation bearing for a bridge which, although compact in size, is capable of efficiently attenuating the vibration in the bridge axis direction of the bridge girder.

### Means for Solving the Problems

A seismic isolation bearing for a bridge in accordance with the present invention comprises: a laminated body having alternately laminated elastic layers and rigid layers; a hollow portion provided in an interior of the laminated body in a hermetically closed manner; and a vibration damping body which is densely filled in the hollow portion and is adapted to damp the vibration in a bridge axis direction of the laminated body, the vibration damping body being constituted by a columnar body having a pair of faces extending in a bridge axis orthogonal direction of the bridge and opposed to each other in the bridge axis direction of the bridge and a pair of faces extending in the bridge axis direction and opposed to each other in the bridge axis orthogonal direction.

In the present invention, a single hollow portion may be provided as the hollow portion in which the vibration damping body is densely filled for damping the shear deformation energy in the bridge axis direction of the laminated body on the basis of the vibration in the bridge axis direction of the bridge girder, but a plurality of hollow portions may be provided in a row in the bridge axis direction and may be provided in a row in the bridge axis orthogonal direction. Furthermore, pluralities of hollow portions may be provided in rows both in the bridge axis direction and in the bridge axis orthogonal direction. In the case where the seismic isolation bearing for a bridge in accordance with the present invention has such a plurality of hollow portions, it suffices if a vibration damping body for damping the vibration in the bridge axis direction of the bridge girder is densely filled in each of the hollow portions.

According to the seismic isolation bearing in accordance with the present invention, since the vibration damping body which damps the vibration in the bridge axis direction of the bridge girder by absorbing the vibrational energy in the bridge axis direction of the bridge girder is constituted by a columnar body having a pair of faces extending in the bridge axis orthogonal direction and opposed to each other in the bridge axis direction and a pair of faces extending in the bridge axis direction and opposed to each other in the bridge axis orthogonal direction, it is possible to make the shear plane in the bridge axis direction large in comparison with a lead plug constituted by a circularly columnar body. As a result, even if the seismic isolation bearing is compact in size, it is possible to efficiently attenuate the vibration in the bridge axis direction of the bridge girder.

In the seismic isolation bearing in accordance with the present invention, a bridge axis direction interval between the pair of faces extending in the bridge axis orthogonal direction and opposed to each other in the bridge axis direction may be greater or smaller than, i.e., may be different from or identical to, a bridge axis orthogonal direction interval between the pair of faces extending in the bridge axis direction and opposed to each other in the bridge axis orthogonal direction.

In the seismic isolation bearing in accordance with the present invention, in a preferred embodiment, edges, extending in a laminated direction, of the columnar body are provided with chamfering, preferably round chamfering. In another preferred embodiment, edges extending in the bridge axis orthogonal direction at a pair of end faces of the columnar body opposed to each other in the laminated direction are provided with chamfering. In still another preferred embodiment, each of a pair of end faces of the columnar body opposed to each other in the laminated direction has a pair of curved surfaces formed by subjecting edges extending in the bridge axis orthogonal direction at each of the pair of end faces to round chamfering and a flat surface situated between the pair of curved surfaces in the bridge axis direction.

In the seismic isolation bearing in accordance with the present invention, if the edges extending in the bridge axis orthogonal direction at the pair of end faces of the columnar body opposed to each other in the laminated direction are provided with chamfering as flow guiding concave surfaces, it is possible to effectively ensure the flow of the vibration damping body at one end portion in the laminated direction of the hollow portion in the shear deformation in the bridge axis direction B of the laminated body on the basis of the vibration in the bridge axis direction of the bridge girder, with the result that the seismic isolation effect can be improved further.

In the seismic isolation bearing in accordance with the present invention, in a preferred embodiment, the vibration damping body is formed of a damping material which absorbs vibrational energy through plastic deformation, and such a damping material may be constituted of lead, tin, zinc, aluminum, copper, nickel, or an alloy thereof or a non-lead-based low melting point alloy including a superplastic alloy such as a zinc-aluminum alloy, or may be constituted of a non-lead-based low melting point alloy (e.g., a tin-containing alloy selected from a tin-zinc-based alloy, a tin-bismuth-based alloy, and a tin-indium-based alloy; specifically, such as a tin-bismuth alloy containing 42 to 43 wt. % of tin and 57 to 58 wt. % of bismuth). In still another preferred embodiment, the vibration damping body is formed of a damping material which effects the absorption of vibrational energy through plastic flow thereof, and such a damping material may include a thermoplastic resin or a thermosetting resin, and a rubber powder. Specifically, the damping material may include a thermally conductive filler for attenuating the applied vibration through mutual friction, graphite for attenuating the applied vibration through friction with at least the thermally conductive filler, and a tackifier resin for imparting adhesiveness.

As the material of the elastic layer in the seismic isolation bearing in accordance with the present invention, it is possible to cite rubbers such as natural rubber, silicone rubber, highly damping rubber, urethane rubber, or chloroprene rubber, but natural rubber is preferable. Each of the elastic layers such as rubber plates formed of such a rubber preferably has a thickness of 1 mm to 30 mm or thereabouts in a no-load condition, but the invention is not limited to the same. In addition, as preferred embodiment of the rigid layer, it is possible to cite a steel plate, a fiber-reinforced synthetic resin plate or fiber-reinforced hard rubber plate using a carbon fiber, a glass fiber, an aramid fiber, or the like. Each of the rigid layers may have a thickness of 1 mm to 6 mm or thereabouts, or the uppermost and lowermost rigid layers in the laminated direction may have a thickness of, for example, 10 mm to 50 mm or thereabouts, which thickness is greater than the rigid layers other than the uppermost and lowermost rigid layers, i.e., those disposed between the uppermost and lowermost rigid layers, but the invention is not limited to the same. In addition, the elastic layers and the rigid layers in terms of their numbers are not particularly limited, and the numbers of the elastic layers and the rigid layers may be determined to obtain stable seismic isolation characteristics from the viewpoints of the load of the bridge girder, the amount of shear deformation (amount of horizontal strain), the modulus of elasticity of the elastic layers, and the estimated magnitude of vibration acceleration to the girder

In addition, in the present invention, the hollow portion provided in the interior of the laminated body in a hermetically closed manner may be singular, but may alternatively be plural, and vibration damping bodies may be respectively disposed in these hollow portions, such that all or some of the plurality of hollow portions are defined by the inner peripheral surfaces of the above-described elastic layers and rigid layers and flow guiding concave surfaces, thereby restricting the vibration damping bodies by these inner peripheral surfaces and flow guiding concave surfaces.

### Advantages of the Invention

According to the present invention, it is possible to provide a seismic isolation bearing for a bridge which, although compact in size, is capable of efficiently attenuating the vibration in the bridge axis direction of the bridge girder.

### BRIEF DESCRIPTION OF THE DRAWINGS

FIG. 1 is an explanatory cross-sectional view of a preferred embodiment for carrying out the invention;

FIG. 2 is an explanatory cross-sectional view taken in the direction of arrows along line II-II in the embodiment shown in FIG. 1;

FIG. 3 is a detailed explanatory perspective view of a lead plug in the embodiment of FIG. 1;

FIG. 4 is a diagram explaining the operation in the embodiment of FIG. 1;

FIG. 5 is an explanatory cross-sectional view of another preferred embodiment of the invention;

FIG. 6 is an explanatory cross-sectional view taken in the direction of arrows along line VI-VI in the embodiment shown in FIG. 5;

FIG. 7 is an explanatory cross-sectional view of still another preferred embodiment of the invention and corresponds to FIG. 6;

FIG. 8 is an explanatory cross-sectional view of a further preferred other embodiment of the invention;

FIG. 9 is a detailed explanatory perspective view of a lead plug and lid members in the embodiment of FIG. 8; and

FIG. 10 is an explanatory cross-sectional view of a still further preferred other embodiment of the invention.

### MODE FOR CARRYING OUT THE INVENTION

Hereafter, a detailed description will be given of the mode for carrying out the invention on the basis of preferred embodiments illustrated in the drawings. It should be noted that the present invention is not limited to these embodiments.

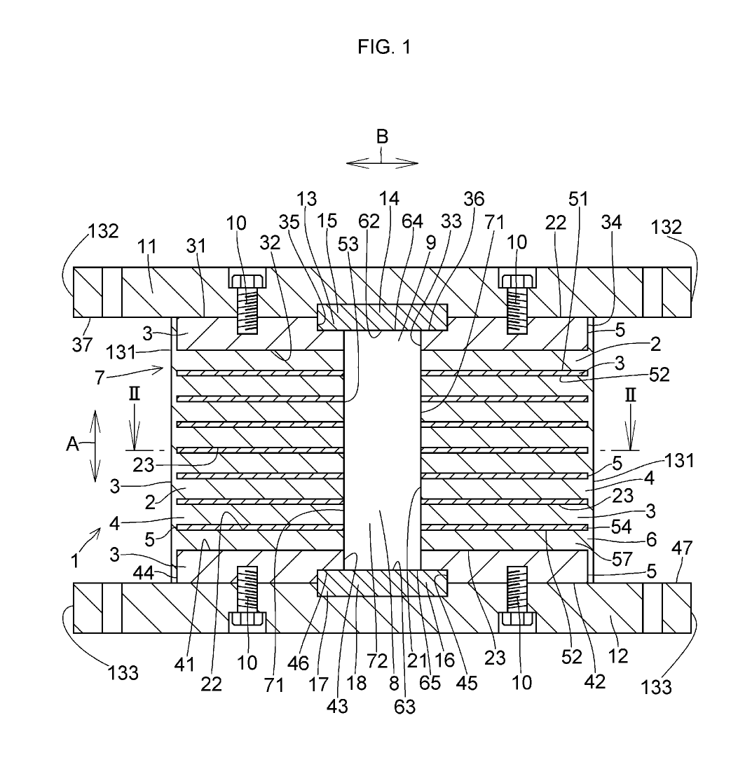

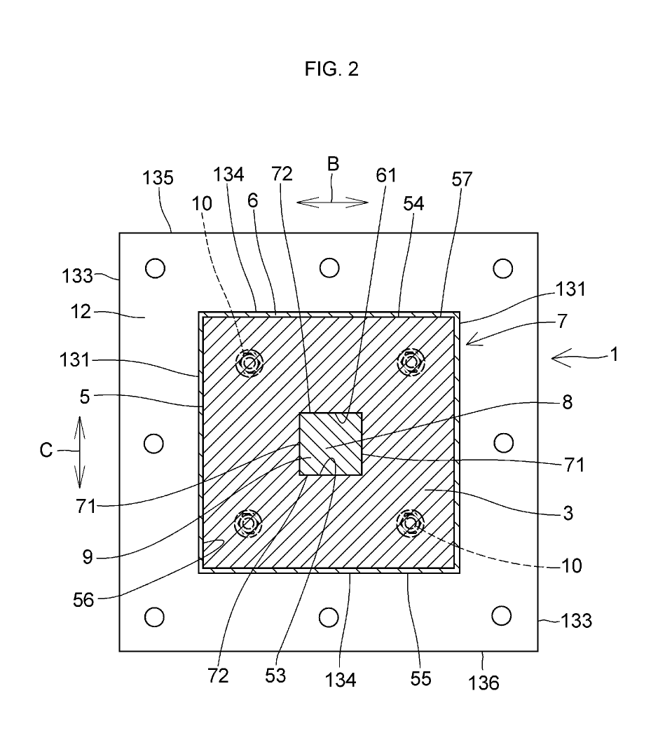

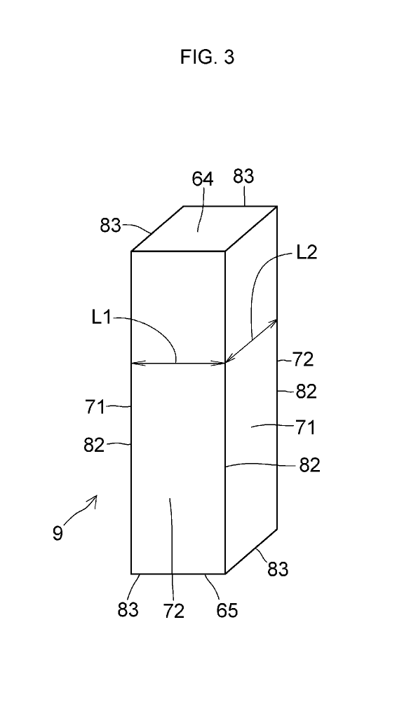

In FIGS. 1 to 3, a seismic isolation bearing 1 for a bridge in accordance with this embodiment is comprised of a rectangular cylindrical (quadrangular cylindrical) laminated body 7 including a plurality of rectangular annular (quadrangular annular) rubber plates 2, serving as elastic layers, and a plurality of rectangular annular (quadrangular annular) steel plates 3, serving as rigid layers, which are alternately superposed one on top of another, as well as a rectangular cylindrical (quadrangular cylindrical) coating layer (outer peripheral protective layer) 6 coating rectangular cylindrical (quadrangular cylindrical) outer peripheral surfaces 4 and 5 of the rubber plates 2 and the steel plates 3 and formed of a rubber material excelling in weather resistance; a quadrangular prism-like hollow portion 8 provided in the interior of the laminated body 7 in a hermetically closed manner and extending in a laminated direction A; a lead plug 9 serving as a vibration damping body which is densely filled in the hollow portion 8 and is adapted to damp the vibration (shear vibration) in a bridge axis direction B of the laminated body 7 by absorbing vibrational energy (shear energy) in the bridge axis direction B of the laminated body 7 through plastic deformation; an upper flange plate 11 and a lower flange plate 12 which are quadrangular plate-shaped and are respectively coupled and fixed to the uppermost and lowermost steel plates 3 in the laminated direction V among the steel plates 3 via bolts 10; a quadrangular plate-shaped shear key 15 fitted in a quadrangular annular recess 13 of the uppermost steel plate 3 and in a quadrangular plate-shaped recess 14 of the upper flange plate 11; and a quadrangular plate-shaped shear key 18 fitted in a quadrangular annular recess 16 of the lowermost steel plate 3 and in a quadrangular plate-shaped recess 17 of the lower flange plate 12.

Each of the plurality of rubber plates 2 includes, in addition to the outer peripheral surface 4, a rectangular cylindrical (quadrangular cylindrical) inner peripheral surface 21, a quadrangular annular upper surface 22 which is an upper quadrangular annular surface in the laminated direction V, and a quadrangular annular lower surface 23 which is a lower quadrangular annular surface in the laminated direction V.

The plurality of steel plates 3 consist of the uppermost and lowermost steel plates 3 in the laminated direction V and the plurality of steel plates 3 disposed between the uppermost and lowermost steel plates 3 in the laminated direction V and each having a thickness in the laminated direction V thinner than the thickness of the respective uppermost and the lowermost steel plate 3 in the laminated direction V.

The uppermost steel plate 3 has a quadrangular annular upper surface 31 and a quadrangular annular lower surface 32 which are respectively on upper and lower sides in the laminated direction V, an inner peripheral surface 33 and an outer peripheral surface 34 each having a rectangular cylindrical (quadrangular cylindrical) shape, a rectangular cylindrical (quadrangular cylindrical) inner peripheral surface 35 defining the recess 13 and disposed outwardly of the inner peripheral surface 33 in the bridge axis direction B and in a bridge axis orthogonal direction C perpendicular to the bridge axis direction B, and a quadrangular annular recessed bottom surface 36 defining the recess 13 in cooperation with the inner peripheral surface 35. At the upper surface 31, the uppermost steel plate 3 is in close contact with a quadrangular annular lower surface 37 of the upper flange plate 11, while, at the lower surface 32, the uppermost steel plate 3 is vulcanization bonded to the upper surface 22 of the rubber plate 2 adjacent to the uppermost steel plate 3 in the laminated direction V and is thereby tightly secured to that upper surface 22.

The lowermost steel plate 3 has a quadrangular annular upper surface 41 and a quadrangular annular lower surface 42 which are respectively on upper and lower sides in the laminated direction V, an inner peripheral surface 43 and an outer peripheral surface 44 each having a rectangular cylindrical (quadrangular cylindrical) shape, a rectangular cylindrical (quadrangular cylindrical) inner peripheral surface 45 defining the recess 16 and disposed outwardly of the inner peripheral surface 43 in the bridge axis direction B and in the bridge axis orthogonal direction C, and a quadrangular annular recessed top surface 46 defining the recess 16 in cooperation with the inner peripheral surface 45. At the lower surface 42, the lowermost steel plate 3 is in close contact with a quadrangular annular upper surface 47 of the lower flange plate 12, while, at the upper surface 41, the lowermost steel plate 3 is vulcanization bonded to the lower surface 23 of the rubber plate 2 adjacent to the lowermost steel plate 3 in the laminated direction V and is thereby tightly secured to that lower surface 23.

Each of the plurality of steel plates 3 disposed between the uppermost and lowermost steel plates 3 has a quadrangular annular upper surface 51 and a quadrangular annular lower surface 52 which are respectively on upper and lower sides in the laminated direction V, as well as an inner peripheral surface 53 and an outer peripheral surface 54 each having a rectangular cylindrical (quadrangular cylindrical) shape. At the upper surface 51, each of these interposed steel plates 3 is vulcanization bonded to the lower surface 23 of the rubber plate 2 upwardly adjacent thereto in the laminated direction V and is thereby tightly secured to that lower surface 23, while, at the lower surface 52, each of these interposed steel plates 3 is vulcanization bonded to the upper surface 22 of the rubber plate 2 downwardly adjacent thereto in the laminated direction V and is thereby tightly secured to that upper surface 22.

The coating layer 6, which has an outer peripheral surface 55 and an inner peripheral surface 56 with a rectangular cylindrical (quadrangular cylindrical) shape and has a layer thickness of preferably 5 to 10 mm or thereabouts, is, at the inner peripheral surface 56, coated on and vulcanization bonded to, an outer peripheral surface 57 consisting of the outer peripheral surfaces 4, 5, and 54 arranged flush with each other in the laminated direction V.

The hollow portion 8 is defined by a quadrangular cylindrical inner peripheral surface 61 consisting of the inner peripheral surfaces 21, 33, 43, and 53 arranged flush with each other in the laminated direction V as well as by a square lower surface 62 of the shear key 15 and a square upper surface 63 of the shear key 18. The lower surface 62 is in close contact with a square upper end face 64 of the lead plug 9 in the laminated direction V, while the upper surface 63 is in close contact with a square lower end face 65 of the lead plug 9 in the laminated direction V.

As the lead plug 9 of a quadrangular prism-like shape, lead with purity of 99.9% or higher and having a volume of 1.01-fold the volume of the hollow portion 8 in the case where the seismic isolation bearing 1 is not subjected to a load in the laminated direction V is filled in that hollow portion 8 without a gap. Thus, the lead plug 9 at the portion of the inner peripheral surface 21 is extruded outwardly in the bridge axis direction B and the bridge axis orthogonal direction C and is hence deformed in such a manner as to be curved in a slightly convex shape. However, if this slight curved deformation is ignored, the lead plug 9 is constituted by a rectangular parallelepiped columnar body having, in addition to the upper end face 64 and the lower end face 65, a pair of rectangular faces 71 extending in the bridge axis orthogonal direction C and opposed to each other in the bridge axis direction B and a pair of rectangular faces 72 extending in the bridge axis direction B and opposed to each other in the bridge axis orthogonal direction C.

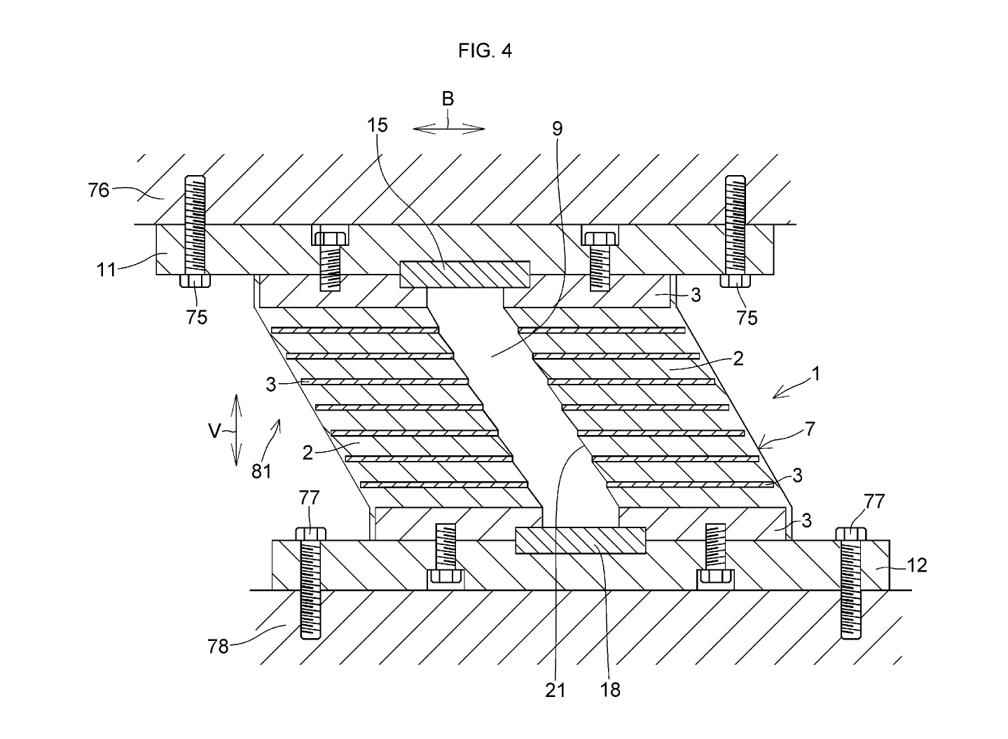

Each of the upper flange plate 11 and the lower flange plate 12 is formed of a steel plate having a thickness in the laminated direction V identical to those of the uppermost and lowermost steel plates 3. As shown in FIG. 4, the upper flange plate 11 is adapted to be fixed via anchor bolts 75 to, for example, one end in the bridge axis direction B of an elongated bridge girder 76 extending in the bridge axis direction B, while the lower flange plate 12 is adapted to be fixed via anchor bolts 77 to, for example, a bridge pier 78 at one end in the bridge axis direction B, as similarly shown in FIG. 4.

The bridge girder 76 at the other end thereof in the bridge axis direction B or, in some cases, at least at one location selected between the other end thereof in the bridge axis direction B and an intermediate portion between one end and the other end thereof is borne on another bridge pier at that location in a seismically isolated manner via a seismic isolation bearing similar to this seismic isolation bearing 1.

The shear key 15 formed of a steel plate and fitted closely in the recess 13 and the recess 14 is adapted to prevent the relative displacement in the bridge axis direction B and the bridge axis orthogonal direction C of the upper flange plate 11 relative to the uppermost steel plate 3, while the shear key 18 formed of a steel plate and fitted closely in the recess 16 and the recess 17 is adapted to prevent the relative displacement in the bridge axis direction B and the bridge axis orthogonal direction C of the lower flange plate 12 relative to the steel plate 3.

The seismic isolation bearing 1 of this embodiment which includes the plurality of elastically stretchable and deformable rubber plates 2 is compressed in the laminated direction V in response to the elastic deformation in the laminated direction V of the rubber plates 2 based on the load of the bridge girder 76 in the support of the bridge girder 76, as shown in FIG. 4. However, in this case as well, the lead plug 9 at the portion of the inner peripheral surface 21 is extruded outwardly in the bridge axis direction B and the bridge axis orthogonal direction C and is hence deformed in such a manner as to be curved in a slightly convex shape.

In a bridge 81 equipped with the above-described seismic isolation bearing 1, the bridge pier 78 fixedly supporting the lower flange plate 12, i.e., the lower end of the seismic isolation bearing 1, through the anchor bolts 77, and the bridge girder 76 fixedly supported by the upper flange plate 11, i.e., the upper end of the seismic isolation bearing 1, through the anchor bolts 75, as for the seismic isolation bearing 1 which is subjected to the load in the laminated direction V of the bridge girder 76, the laminated body 7 undergoes shear deformation in the bridge axis direction B, as shown in FIG. 4, owing to the displacement (vibration) in the bridge axis direction B of the bridge pier 78 due to an earthquake or the like. As the laminated body 7 undergoes shear deformation in the bridge axis direction B, the transmission of ground vibration in the bridge axis direction B due to an earthquake or the like, viz., the vibration in the bridge axis direction B of the bridge pier 78, to the bridge girder 76 is prevented as practically as possible by the shear deformation in the bridge axis direction B of the respective rubber plates 2 of the laminated body 7, and the vibration of the bridge girder 76 in the bridge axis direction B transmitted to the bridge girder 76 is damped as speedily as possible through the plastic deformation of the lead plug 9.

According to the above-described seismic isolation bearing 1, since the lead plug 9 which damps the vibration in the bridge axis direction B of the bridge girder 76 by absorbing the vibrational energy in the bridge axis direction B of the bridge girder 76 is constituted by a rectangular parallelepiped columnar body having the pair of faces 71 extending in the bridge axis orthogonal direction C and opposed to each other in the bridge axis direction B and the pair of faces 72 extending in the bridge axis direction B and opposed to each other in the bridge axis orthogonal direction C, it is possible to make the shear plane in the bridge axis direction B large in comparison with a lead plug constituted by a circularly columnar body. As a result, even if the seismic isolation bearing 1 is compact in size, it is possible to efficiently attenuate the vibration in the bridge axis direction B.

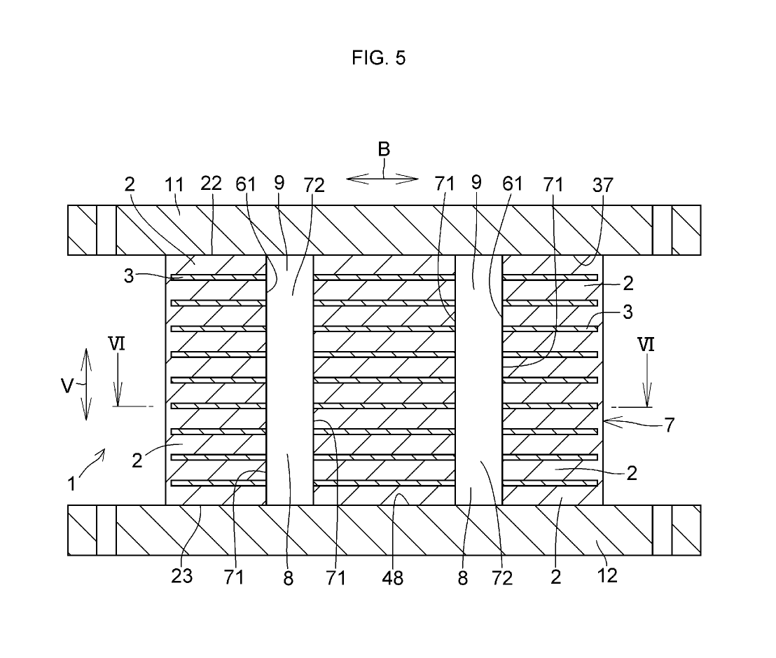

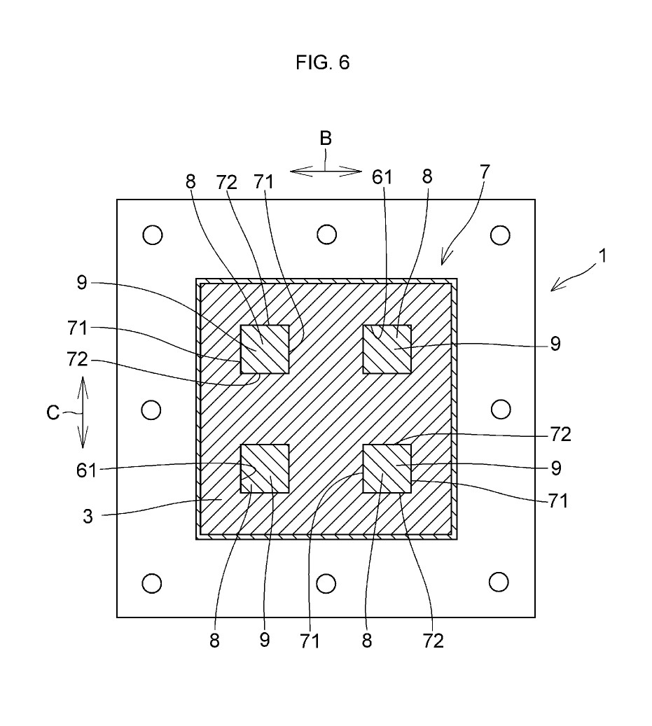

The above-described seismic isolation bearing 1 has a single hollow portion 8 and the lead plug 9 which is densely filled in the single hollow portion 8. Alternatively, however, the seismic isolation bearing 1 may have a plurality of hollow portions 8 provided in a plurality of rows in at least one of the bridge axis direction B and the bridge axis orthogonal direction C, e.g., as shown in FIGS. 5 and 6, four hollow portions 8 arranged in two rows on both sides in the bridge axis direction B and the bridge axis orthogonal direction C, and lead plugs 9 which are respectively filled in the four hollow portions 8. In this case as well, it suffices if each of the lead plugs 9 is constituted by a columnar body having the pair of faces 71 extending in the bridge axis orthogonal direction C and opposed to each other in the bridge axis direction B and the pair of faces 72 extending in the bridge axis direction B and opposed to each other in the bridge axis orthogonal direction C.

In addition, in the seismic isolation bearing 1 in the embodiment shown in FIG. 1, the plurality of steel plates 3 as the plurality of rigid layers consist of the uppermost and lowermost steel plates 3, which are respectively coupled and fixed to the upper flange plate 11 and the lower flange plate 12 via the bolts 10, and the plurality of steel plates 3 disposed between the uppermost and lowermost steel plates 3 and each having a thickness in the laminated direction V thinner than the thickness of the respective uppermost and the lowermost steel plate 3 in the laminated direction V. Alternatively, however, as shown in FIG. 5, while the shear keys 15 and 18 are omitted, the plurality of steel plates 3 respectively having the same thickness in the laminated direction V and each having four inner peripheral surfaces 53 arranged in two rows on both sides in the bridge axis direction B and the bridge axis orthogonal direction C may be disposed between the uppermost and lowermost rubber plates 2 in the laminated direction V among the plurality of rubber plates 2 respectively having the same thickness in the laminated direction V and each having four inner peripheral surfaces 21 arranged in two rows on both sides in the bridge axis direction B and the bridge axis orthogonal direction C, such that the steel plates 3 and the rubber plates 2 are alternately laminated and the steel plates 3 are respectively disposed on and vulcanization bonded to the rubber plates 2. In addition, while the bolts 10 are omitted, the uppermost and lowermost rubber plates 2 at the upper surface 22 and the lower surface 23 thereof may be respectively vulcanization bonded to the lower surface 37 and the upper surface 48, in which case each hollow portion 8 is defined by the lower surface 37 and the upper surface 47 in addition to the quadrangular cylindrical inner peripheral surface 61 consisting of the pluralities of inner peripheral surfaces 21 and 53.

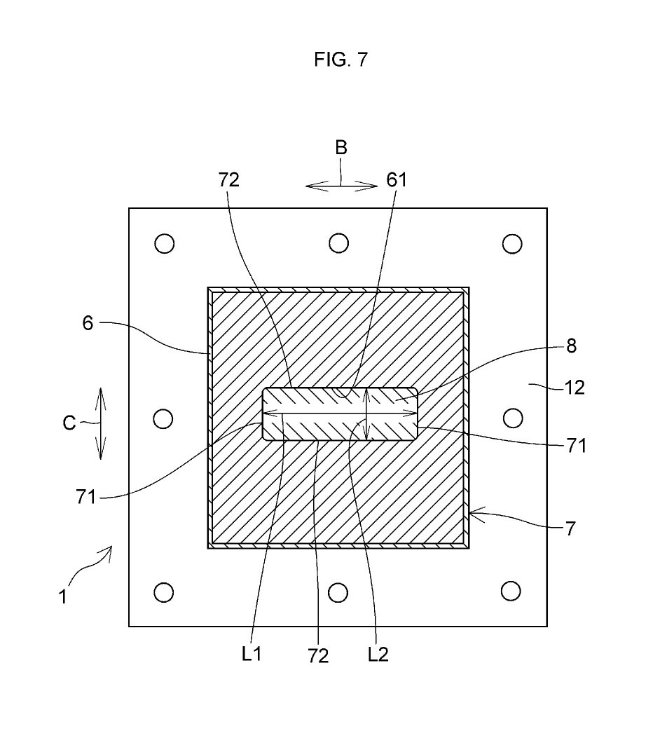

In addition, in the above-described seismic isolation bearing 1, the hollow portion 8 is defined by the inner peripheral surface 61, the lower surface 62, and the upper surface 63 such that a bridge axis direction interval L1 between the pair of faces 71 in the lead plug 9 and a bridge axis orthogonal direction interval L2 between the pair of faces 72 are identical to each other, i.e., such that the upper end face 64 and the lower end face 65 become square. Alternatively, however, the hollow portion 8 in which the lead plug 9 is densely filled may be defined by the inner peripheral surface 61, the lower surface 62, and the upper surface 63 such that the bridge axis direction interval L1 between the pair of faces 71 in the lead plug 9 and the bridge axis orthogonal direction interval L2 between the pair of faces 72 are different from each other, e.g., such that, as shown in FIG. 7, the bridge axis direction interval L1 between the pair of faces 71 in the lead plug 9 is greater than the bridge axis orthogonal direction interval L2 between the pair of faces 72, i.e., such that the upper end face 64 and the lower end face 65 become rectangular.

In addition, in the above-described seismic isolation bearing 1, edges 82, extending in the laminated direction V, of the lead plug 9 constituted by a columnar body and edges 83 of the pair of upper end face 64 and lower end face 65 opposed to each other in the laminated direction V may be provided with chamfering, e.g., round chamfering.

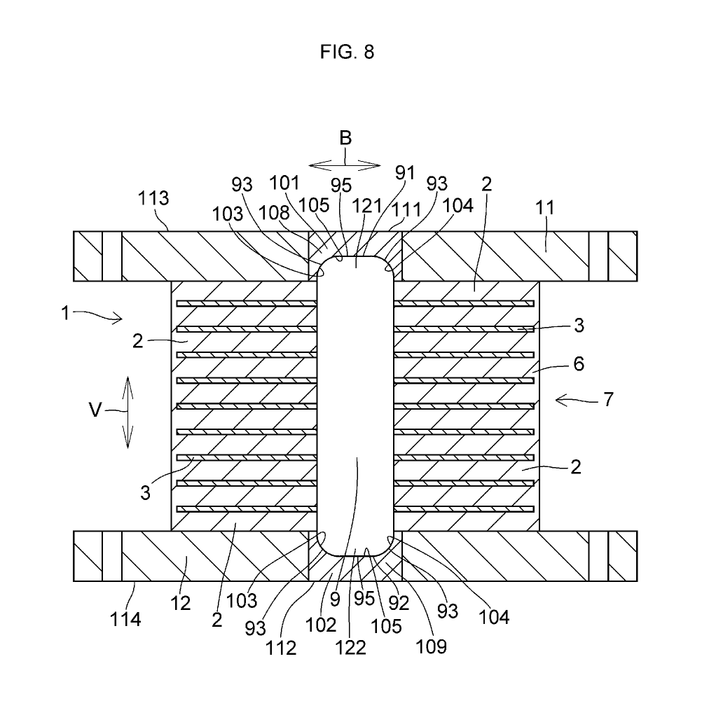

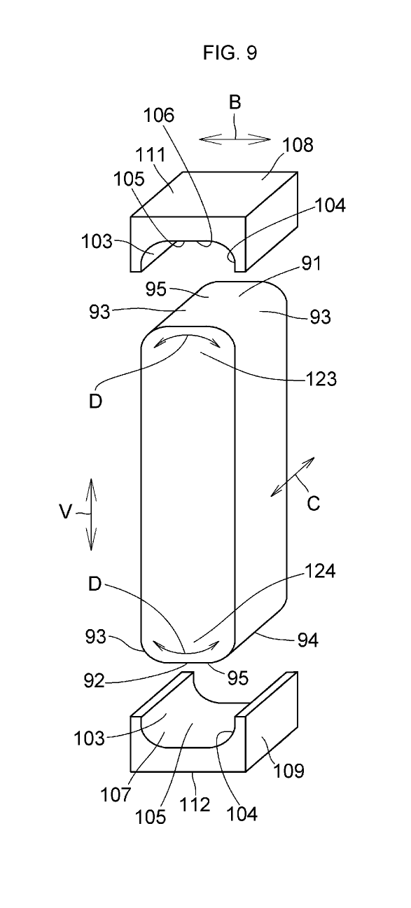

In particular, as shown in FIGS. 8 and 9, in the lead plug 9 constituted by a columnar body, each of a pair of end faces 91 and 92 (corresponding to the upper end face 64 and the lower end face 65) opposed to each other in the laminated direction V may be defined by the inner peripheral surface 61 of the hollow portion 8, the lower surface 62, and the upper surface 63, so as to have a pair of curved surfaces 93 and 94 formed by subjecting the respective edges extending in the bridge axis orthogonal direction C at each of the pair of end faces 91 and 92 to round chamfering, as well as a flat surface 95 situated between the pair of curved surfaces 93 and 94 in the bridge axis direction B.

In addition, in order for each of the pair of end faces 91 and 92 of the lead plug 9 to have the pair of curved surfaces 93 and 94 and the flat surface 95, in substitution of the shear keys 15 and 18, as shown in FIGS. 8 and 9, quadrangular prism-like lid members 108 and 109 respectively having at a lower surface 106 and an upper surface 107 thereof in the laminated direction V a pair of curves surfaces 103 and 104 and a flat surface 105 defining the pair of curved surfaces 93 and 94 and the flat surface 95 may be respectively fitted and fixed in quadrangular prism-like through holes 101 and 102 formed respectively in the upper flange plate 11 and the lower flange plate 12, such that a square upper surface 111 and a square lower surface 112 thereof become flush with a square upper surface 113 of the upper flange plate 11 and a square lower surface 114 of the lower flange plate 12.

In the seismic isolation bearing 1 shown in FIGS. 8 and 9, in the shear deformation in the bridge axis direction B of the lead plug 9 at the time of the vibration in the bridge axis direction B of the bridge pier 78 and the lower flange plate 12, it is possible to effectively ensure the flow D of upper end portions 123 and 124 of the lead plug 9 at upper end portions 121 and 122 which are one end portions in the laminated direction V of the hollow portion 8, with the result that the seismic isolation effect can be improved further.

In the seismic isolation bearing 1 shown in FIGS. 8 and 9, each of the pair of end faces 91 and 92 of the lead plug 9 constituted by a columnar body is defined by the inner peripheral surface 61 of the hollow portion 8 and the lower surface 62 and the upper surface 63 which are constituted by the lower surface 106 and the upper surface 107, so as to have the pair of curved surfaces 93 and 94 and the flat surface 95. Alternatively, however, the end face 91, situated upwardly in the laminated direction V, of the lead plug 9 may be constituted by a part of an upwardly convex cylindrical surface which has an axis extending in the bridge axis orthogonal direction C, while the end face 92 situated downwardly in the laminated direction may be constituted by a part of a downwardly convex cylindrical surface which has an axis extending in the bridge axis orthogonal direction C. In this case, it suffices if each cylindrical surface has a radius of curvature which is equal to or less than one half of the bridge axis direction interval L1, preferably which is one half of the bridge axis direction interval L1.

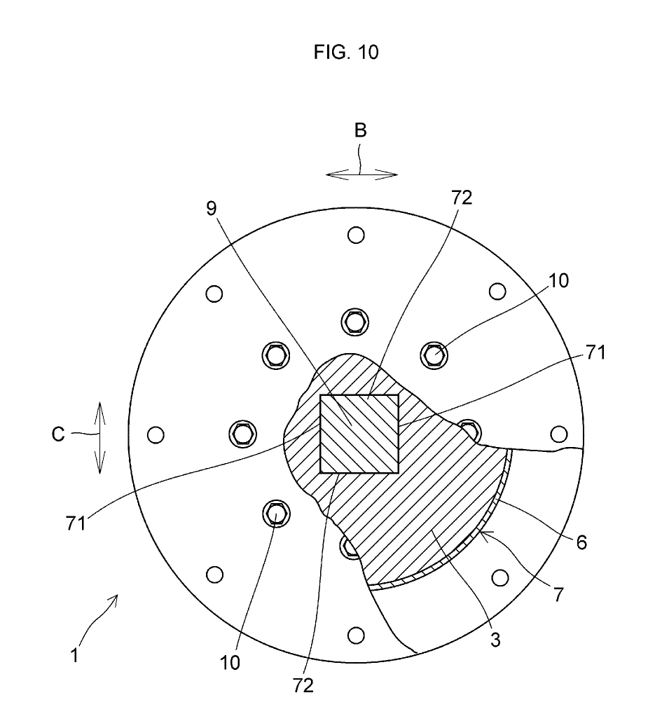

Incidentally, in the above-described seismic isolation bearing 1, the laminated body 7, the upper flange plate 11, and the lower flange plate 12 respectively have pairs of rectangular faces 131, 132, and 133 extending in the bridge axis orthogonal direction C in parallel with the faces 71 and opposed to each other in the bridge axis direction B, as well as pairs of rectangular faces 134, 135, and 136 extending in the bridge axis direction B in parallel with the faces 72 and opposed to each other in the bridge axis orthogonal direction C. Alternatively, however, as shown in FIG. 10, the seismic isolation bearing 1 may be comprised of, in addition to pluralities of annular rubber plates (not shown) and steel plates 3, a cylindrical laminated body 7 having a cylindrical coating layer (outer peripheral protective layer) 6 coating cylindrical outer peripheral surfaces of the rubber plates and the steel plates 3, and an upper flange plate 11 and a lower flange plate 12 which are disk-shaped or annular.

Furthermore, in any one of the above-described seismic isolation bearings 1, the shear keys 15 and 18 are not limited to being quadrangular plate-shaped, but may be disk-shaped, in which case the recesses 13, 14, 16, 17 may also be disk-shaped to allow the disk-shaped shear keys 15 and 18 to be fittingly secured therein.

### DESCRIPTION OF REFERENCE NUMERALS

1: seismic isolation bearing
2: rubber plate
3: steel plate
4, 5: outer peripheral surface
6: coating layer
7: laminated body
8: hollow portion
9: lead plug
10: bolt
11: upper flange plate
12: lower flange plate
13, 14: recess
15, 18: shear key
16, 17: recess

1. A seismic isolation bearing for a bridge comprising:
a laminated body having alternately laminated elastic layers and rigid layers;
a hollow portion provided in an interior of said laminated body in a hermetically closed manner; and
a vibration damping body which is densely filled in said hollow portion and is adapted to damp the vibration in a bridge axis direction of said laminated body,
said vibration damping body being constituted by a columnar body having a pair of faces extending in a bridge axis orthogonal direction of the bridge and opposed to each other in the bridge axis direction of the bridge and a pair of faces extending in the bridge axis direction and opposed to each other in the bridge axis orthogonal direction.

2. A seismic isolation bearing for a bridge comprising:
a laminated body having alternately laminated elastic layers and rigid layers;
a plurality of hollow portions provided in an interior of said laminated body in a hermetically closed manner and arranged in a row in a bridge axis direction; and
vibration damping bodies which are respectively densely filled in said plurality of hollow portions and are adapted to damp the vibration in the bridge axis direction of said laminated body,
each of said vibration damping bodies being constituted by a columnar body having a pair of faces extending in a bridge axis orthogonal direction and opposed to each other in the bridge axis direction and a pair of faces extending in the bridge axis direction and opposed to each other in the bridge axis orthogonal direction.

3. A seismic isolation bearing for a bridge comprising:
a laminated body having alternately laminated elastic layers and rigid layers;
a plurality of hollow portions provided in an interior of said laminated body in a hermetically closed manner and arranged in a row in a bridge axis orthogonal direction; and
vibration damping bodies which are respectively densely filled in said plurality of hollow portions and are adapted to damp the vibration in a bridge axis direction of said laminated body,
each of said vibration damping bodies being constituted by a columnar body having a pair of faces extending in the bridge axis orthogonal direction and opposed to each other in the bridge axis direction and a pair of faces extending in the bridge axis direction and opposed to each other in the bridge axis orthogonal direction.

4. A seismic isolation bearing for a bridge comprising:
a laminated body having alternately laminated elastic layers and rigid layers;
a plurality of hollow portions provided in an interior of said laminated body in a hermetically closed manner and arranged in a plurality of rows extending in a bridge axis direction and arrayed in a bridge axis orthogonal direction; and
vibration damping bodies which are respectively densely filled in said plurality of hollow portions and are adapted to damp the vibration in the bridge axis direction of said laminated body,
each of said vibration damping bodies being constituted by a columnar body having a pair of faces extending in the bridge axis orthogonal direction and opposed to each other in the bridge axis direction and a pair of faces extending in the bridge axis direction and opposed to each other in the bridge axis orthogonal direction.

5. The seismic isolation bearing for a bridge according to claim 1, wherein a bridge axis direction interval between the pair of faces extending in the bridge axis orthogonal direction and opposed to each other in the bridge axis direction and a bridge axis orthogonal direction interval between the pair of faces extending in the bridge axis direction and opposed to each other in the bridge axis orthogonal direction are identical to or different from each other.

6. The seismic isolation bearing for a bridge according to claim 1, wherein edges, extending in a laminated direction, of said columnar body are provided with chamfering.

7. The seismic isolation bearing for a bridge according to claim 1, wherein edges extending in the bridge axis orthogonal direction at a pair of end faces of the columnar body opposed to each other in a laminated direction are provided with chamfering.

8. The seismic isolation bearing for a bridge according to claim 1, wherein each of a pair of end faces of the columnar body opposed to each other in a laminated direction has a pair of curved surfaces formed by subjecting edges extending in the bridge axis orthogonal direction at each of the pair of end faces to round chamfering and a flat surface situated between the pair of curved surfaces in the bridge axis direction.

9. The seismic isolation bearing for a bridge according to claim 1, wherein, between a pair of end faces of the columnar body opposed to each other in a laminated direction, the end face situated upwardly in the laminated direction may be constituted by a part of an upwardly convex cylindrical surface which has an axis extending in the bridge axis orthogonal direction, while, between the pair of end faces of the columnar body opposed to each other in the laminated direction, the end face situated downwardly in the laminated direction is constituted by a part of a downwardly convex cylindrical surface which has an axis extending in the bridge axis orthogonal direction.

10. The seismic isolation bearing for a bridge according to claim 9, wherein each of the cylindrical surfaces has a radius of curvature which is equal to or less than one half of the bridge axis direction interval between the pair of faces extending in the bridge axis orthogonal direction and opposed to each other in the bridge axis direction.

11. The seismic isolation bearing for a bridge according to claim 9, wherein each of the cylindrical surfaces has a radius of curvature which is one half of the bridge axis direction interval between the pair of faces extending in the bridge axis orthogonal direction and opposed to each other in the bridge axis direction.

12. The seismic isolation bearing for a bridge according to claim 1, wherein said vibration damping body is formed of a damping material which effects the absorption of vibrational energy through plastic deformation thereof.

13. The seismic isolation bearing for a bridge according to claim 12, wherein the damping material is constituted of lead, tin, zinc, aluminum, copper, nickel, an alloy thereof or a non-lead-based low melting point alloy.

14. The seismic isolation bearing for a bridge according to claim 1, wherein said vibration damping body is formed of a damping material which effects the absorption of vibrational energy through plastic flow thereof.

15. The seismic isolation bearing for a bridge according to claim 14, wherein the damping material includes a thermoplastic resin or a thermosetting resin, and a rubber powder.

16. A bridge comprising:
the seismic isolation bearing according to claim 1;
a bridge pier which fixedly supports a lower end of the seismic isolation bearing; and
a bridge girder which is fixedly supported on an upper end of the seismic isolation bearing.
